(19) United States
(12) Patent Application Publication
(10) Pub. No.: US 2026/0252847 A1
(43) Pub. Date: Aug. 27, 2026

(54) ADAPTIVE SYSTEMS INCLUDING PRE-TRAINED NEURAL NETWORKS

(71) Applicant: GDM Holding LLC, Mountain View, CA (US)

(72) Inventors: Relja Arandjelovic, Munich (DE); Alexander Joseph Andonian, Lincoln, MA (US); Arthur Mensch, Paris (FR); Olivier Jean Henaff, London (GB); Jean-Baptiste Alayrac, London (GB); Andrew Zisserman, London (GB)

(21) Appl. No.: 19/163,256

(22) PCT Filed: Mar. 7, 2024
(86) PCT No.: PCT/EP2024/056011

§ 371 Date: Sep. 8, 2025

Related U.S. Application Data
(60) Provisional application No. 63/450,933, filed on Mar. 8, 2023.

(51) Int. Cl. G06N 3/045; G06N 3/0464

(52) U.S. Cl. CPC G06N 3/045; G06N 3/0464

(57) ABSTRACT

An adaptive system includes an adaptive unit and a previously trained language model. A data input item to the adaptive system includes a language input for processing by the language model, and a second input a different modality. The second input is processed, such as by a second trained neural network, to generate an input for the adaptive unit. A training database of training examples, each including a data input and a desired outputs of the adaptive system, is used to generate a second training database of additional training examples including an output of a variant of the language model upon receiving the language input, and the second training database is used to train the adaptive unit of the adaptive system. The adaptive unit includes a number of gates which, during an initial part of the training of the adaptive system, cause data to flow though the adaptive unit, so as to preserve alignment of the output of the adaptive unit with the language model.

### CROSS-REFERENCE TO RELATED APPLICATION

This application claims priority to U.S. Provisional Application No. 63/450,933, filed on Mar. 8, 2023. The disclosure of the prior application is considered part of and is incorporated by reference in the disclosure of this application.

### BACKGROUND

This specification relates to employing one or more pre-trained neural networks within an adaptive system. For example, it relates to training an adaptive unit of an adaptive system which also includes a pre-trained neural network.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters. The layer is “trained” in an iterative process of varying the parameters, e.g. to successively reduce a loss function.

### SUMMARY

This specification describes a system, implemented as computer programs on one or more computers in one or more locations, and a method to train an adaptive system. The adaptive system incorporates at least one previously trained neural network, such as a previously trained language model (sometimes termed a “large language model”). In implementations, the adaptive system also includes at least one previously trained second neural network for processing an input of a different modality, such as an image, a video or a sound.

For example, the adaptive system may comprise two (pre-)trained neural networks and an adaptive unit. The adaptive unit is also called an “adaptive portion” of the adaptive system. As described below, it can be training within the adaptive system; alternatively, it can be trained within a training system, and used to form the adaptive system afterwards. The adaptive unit is defined by a plurality of parameters which are iteratively trained in an adaptive unit training process using the two trained neural networks. During the training process the trained neural networks may either not be varied (they are “frozen”), or only allowed to vary very slowly.

The two trained neural networks may have been trained, upon receiving respective first and second inputs, to generate respective first and second outputs in a common space. The first and second inputs may have different respective modalities. For example, the first input may be a language input (e.g. a sequence of text tokens from a vocabulary of text tokens), and the first of the trained neural networks may be a language model. The second input may be data representing a sound signal, a still image or a video (sequence of images). The neural networks are trained such that, following the training, the similarity of datasets based on the first and second outputs, as measured by a similarity metric, is higher when the language input comprises semantic content which is also present in the second input (i.e. the language input and second input are “semantically corresponding”). That is, when the tokens of the language input describe content present in the second input. In this case the first and second trained neural networks are said to be “aligned”.

For example, if the second input is a video or image, the first and second outputs may have a higher value of a similarity measure if the second input depicts (i.e. as patterns of the pixel intensity values, not as metadata) an object which is described by one or more words of the language input. Alternatively, if the second input is a sound item, the first and second outputs may have a higher value of a similarity measure if the second input represents (e.g. as time or frequency domain amplitude values, not as metadata) a sound of an object which is described by one or more words of the language input (e.g. the bark of a “dog” mentioned in the language input).

The input to the adaptive system is a “data input item” (or “multi-modal input) which comprises first and second inputs respectively for the first and second trained neural networks, and the first and second trained neural networks generate respective first and second outputs. The adaptive unit may be configured to receive, as input, an output of the second trained neural network, and from it to produce sets of classification features and corresponding items of label data. A set of classification features may for example represent a corresponding object present in the second input, with the corresponding item of label data giving information about the object, for example defining the position of the object in the second input. The adaptive system is configured to generate an output which is based on a selection from the label data based on the first output (e.g. a language model output, e.g. a text embedding) and the sets of classification features. The output is indicative of the location in the second input of objects semantically related to the language input.

In general terms, a first aspect of the disclosure proposes that training examples which are data input items, are used to produce a plurality of “additional” training examples including outputs produced by one or more variant(s) of a trained language model upon receiving corresponding first inputs (i.e. portions of language, e.g. portions of natural language text) from the training examples. The additional training examples can be used as at least part of a “second” training database which is subsequently used to train an adaptive unit of an adaptive system (such as the one described above) incorporating the trained language model. Thus, the trained language model is not required during the training of the adaptive unit. In other words, the training of the adaptive unit may be performed in a training system which includes the adaptive unit and the second training neural network, but in which the trained language model is replaced by the second training database. Once the training of the adaptive unit is complete, the adaptive system can be formed using the first and second trained neural networks and the trained adaptive unit.

A second aspect of the disclosure, freely combinable with the first aspect of the disclosure, proposes in general terms that during the training process of an adaptive unit of an adaptive system including two trained neural networks, one or more elements (“processing units”) of the adaptive unit which adaptively (i.e. according to trainable parameters of the processing units) modify data obtained from the second neural network, are each provided with a corresponding controllable gate to modify the output of the processing unit. The processing unit may, for example, be an adaptive filter module, i.e. it may provide an adaptive (i.e. trainable) filter. The adaptive filter may be a convolution, and/or it may be a portion of a detection head. The gate is controllable (e.g. based on a corresponding controllable parameter) to generate an output which is a weighted sum of the input to the processing unit (or a version of the input to the processing unit, such as an up- or down-sampled version, which does not damage the alignment, i.e. it is still aligned with the language model) and the output of the processing unit (i.e. the result of applying a function defined by the processing unit to the input to the processing unit). Initially during the training of the adaptive unit, the controllable parameter of the gate is set such that gate produces an output which is substantially the same as the input to the processing unit (or the still-aligned version of the input mentioned above). During the training of the adaptive unit, the controllable parameter may be modified (e.g. incrementally) to increase the influence of the function in determining the output of the gate (though not necessarily monotonously, especially later in the training procedure).

This has an advantage that, initially, data generated by the second trained neural network may pass through the adaptive unit unmodified by the processing units, to form the classification features. Thus, if the first and second trained neural networks have been trained to produce respective first and second outputs which are aligned in (in the semantic sense explained above), that relationship applies also initially to the first output and the classification features. In other words, the adaptive unit may be trained from an initial condition in which it does not disrupt the pre-trained alignment relationship of the first and second trained neural networks. It has been found that this may reduce the computational resources required to train the adaptive unit of the adaptive component, and/or may improve the performance of the trained adaptive system.

Note that in some implementations of the second aspect of the disclosure, the training of the adaptive unit is performed within the adaptive system, while in other implementations (e.g. those which are also according to the first aspect of the invention) it is performed within a training system in which the language model is replaced by a training database of training items comprising language model outputs.

As noted above, the input to the adaptive system may be a data input item which comprises first and second inputs, for processing respectively by the first and second trained neural networks, and the first and second trained neural networks generate therefrom respective first and second outputs. When used in the adaptive system, the (e.g. trained) adaptive unit may be configured to receive, as input, an output of the second trained neural network, and from it to produce sets of classification features and corresponding items of label data. A set of classification features may for example represent an object present in the second input, with the corresponding item of label data giving information about the object, for example defining the position of the object in the second input. The adaptive system is configured to generate an output which is based on a selection from the label data based on the first output and the sets of classification features.

In both aspects of the disclosure, the second neural network may take any form, though it may be a feed-forward neural network having a sequence of layers which each (except the first) process an output of the preceding layer of the sequence. In some implementations, particularly if the second input is an image or sequence of images, each of the layers may be implemented as a convolutional layer. Each layer outputs a feature vector (feature map, which is one or more numerical values for each of an (e.g., two-dimensional, square or rectangular) array of pixels; the number of pixels of the array is referred to as a pixel array size, and the “dimensionality” of a feature map is the number of numerical values per pixel times the pixel array size). The successive layers of the sequence may be configured to generate respective feature vectors of gradually decreasing pixel array size, and in some cases reducing dimensionality (note that the number of numerical values per pixel in a feature map produced by a given layer of the sequence may not reduce from layer to layer, and may even increase), representing a successively less fine-grained representation of the second input of the data input item. The output of the second neural network which is the input to the adaptive unit of the adaptive system may be one or more of the feature maps generated by respective ones of the layers of the second neural network.

The adaptive unit may comprise a plurality of processing layers (which may also be termed adaptive layers). The processing layers may be a sequence of layers, each arranged to receive (from a corresponding layer of the second network and/or from another of the processing layers of the adaptive unit) one or more feature vectors (feature maps). The processing layers may form a “feature pyramid” network, FPN. In this case, the layers are arranged in a sequence such that, for processing layers later in the sequence, the feature maps which the corresponding processing layers output have gradually reducing corresponding pixel array sizes (and in some case dimensionalities). Each processing layer may apply one or more of adaptive filters, such as adaptive convolutional functions, to the feature vector(s) (feature map(s)) it receives (e.g. if it receives a plurality of feature maps, to either of those features maps and/or to a sum of those feature maps), to generate a feature vector (feature map). For some processing layers, this may have the same dimensionality (e.g. pixel array size and number of numerical values per pixel) as the feature vector(s) it receives. However, for other processing layers, the processing layer may include an up- or down-sampling, or an adaptive convolutional function with a stride (greater than one), to change the pixel array size.

Some or all of the processing layers may be arranged to receive feature vectors from corresponding ones of the layers of the second neural network.

Also, some of all of the processing layers may be configured to receive feature vectors from other of the processing layers, e.g. with an up- or down-sampling to convert the dimensionality (pixel array size) of a feature vector produced by one of the processing layers to be the dimensionality of the processing layer which receives it (e.g. to be the same dimensionality as other feature maps the latter processing layer receives).

The adaptive unit may further include a plurality of detection heads, e.g. one for each of the processing layers. Each detection head is arranged to receive the feature vector (feature map) output by the corresponding one of the processing layers, and to generate, from the received feature vector, sets of classification features and corresponding items of label data. The set of classification features, and optionally the label data, may be one or more numerical values for each of an array of pixels, and have the same dimensionality (e.g. pixel array size and number of numerical values per pixel) as the feature map the detection head receives.

The output of the adaptive system may be generated based on the classification features, the label data and the language model outputs. For example, the output of the adaptive system, for a given data input item, may comprise at least one selected portion of the label data. The selected portion may be selected based on the corresponding classification features and the language model output. For example, similarity scores may be defined comparing respective sets of classification features to the first output (the output of the first trained neural network, e.g. the language model); for example, the similarity score may be a dot product of the corresponding set of classification features and the first output (the output of the first trained neural network). The label data may be selected based on the corresponding similarity score of the corresponding set of classification features.

Each item of label data may be in the form of data which identifies portions of the second input (i.e. a portion of the data input item which the second trained neural network receives). In one case, an element of the label data (e.g. a set of numerical values for a given pixel of the label data) may indicate the position of a portion of the second input having a content defined by a corresponding element of the classification features (e.g. a set of numerical values for a given pixel of the classification features).

The detection head may also produce a quality score. This too may be an array of data: one or more numerical values for each of an array of pixels. The quality score array corresponds to the array of classification features and the array of label data. In general terms, the numerical values of an element of the quality score may indicate a degree of confidence that an object having the properties defined by the corresponding element of the classification features is present at a portion of the second input defined by the corresponding element of the label data. In cases in which a quality score exists, the similarity score for a given set of classification features may be weighted by the corresponding quality score to give a final score for the set of classification features. If the detection heads do not produce quality scores, the final score for each item of label data may just be the corresponding similarity score.

The output of the output of the adaptive system may comprise label data selected based on the corresponding final scores. For example, it may be the element of the label data for which the corresponding final score is highest. Alternatively, it may be all the elements of label data for which the corresponding final scores are above a threshold. Alternatively, if no element of label data has a corresponding final score above the threshold, the output may be an indication that this is the case.

Following a process of training the adaptive unit (according to either aspect of the disclosure) using a training database of training examples, the trained adaptive unit may be used to produce a “semi-trained” adaptive system (e.g. by combining it with the trained language model and the trained second neural network). The “semi-trained” adaptive system may be used in a “self-learning” process. That is, it is used to generate, for a plurality of additional data input items received by the adaptive system, a plurality of corresponding outputs of the adaptive system. Based on the corresponding outputs, more additional training examples may be defined and added to the second training database. The additional training examples may each comprise the corresponding additional data input item and the corresponding output of the adaptive system; or, in the case of the first aspect of the disclosure, each additional training item may comprise the second input of a corresponding additional data input item, an output of the language model (or a variant thereof) based on the language input of the additional data input item, and the corresponding output of the adaptive system. The training base, thus supplemented, is used for additional training of the adaptive unit of the adaptive system. Although the output of the (semi-trained) adaptive system (a “pseudo-label”) may not be exactly accurate, it has been found experimentally that this procedure leads to improved performance by the trained adaptive system.

Optionally, the training of the adaptive unit may be performed in a batch process using a batch of training examples in the training database. In the case of a batch using one or more of the additional training examples, it has been found advantageous to treat the first inputs of the other training examples of the batch as being negatively correlated with the second inputs of the additional training examples. For example, the adaptive system may be modified in a batch update such that, upon receiving a first input of one of the additional training examples, the likelihood that the adaptive system outputs the output specified by another of the training examples of the batch, is reduced.

### BRIEF DESCRIPTION OF THE DRAWINGS

Examples of adaptive systems, and methods of training adaptive systems, are now described with reference to the following figures in which like elements are designated by the same reference numerals, and in which

FIG. 1 shows schematically the training of first and second neural networks;

FIG. 2 shows an adaptive system including the trained first and second neural networks;

FIG. 3 shows a visual backbone and a first realization of an adaptive unit of the adaptive system of FIG. 2;

FIG. 4A shows a system for generating additional training examples using a training database;

FIG. 4B shows a training system for an adaptive unit of the adaptive system of FIG. 2;

FIG. 4C shows a training method for an adaptive unit of the adaptive system of FIG. 2;

FIG. 5 shows a gate employed in a second realization of the adaptive unit of the adaptive system of FIG. 2;

FIG. 6 shows a visual backbone and the second realization of an adaptive unit of the adaptive system of FIG. 2; and

FIG. 7 shows a training method for an adaptive unit such as that shown in FIG. 6.

### DETAILED DESCRIPTION

A language model (or “large language model”) is a computer model which is configured (trained) to receive a “language input”, that is a sequence of tokens from a vocabulary. The language input may be a word, or a sequence of multiple words, from a language, e.g. a natural language. The tokens of the vocabulary may comprise letters, words and/or portions of words. The language model generates an output (“a language model output”) from the language input. The language model output is a “text embedding” of the language input. It may be composed of data encoding tokens from a vocabulary, or composed of other data.

Multi-modal models receive a data input which includes a language input and a second data input with a different modality e.g. a (still or moving) image or a sound signal. Some multi-modal models perform a task which is to identify, within the second data input, content which described by the language input.

One form of this task is “zero shot” (ZS) “open vocabulary” (OV) detection. A multimodal model (“open vocabulary detector”) is formed using a pre-trained language model. The multimodal model is an adaptive system and it is trained to perform the task of detecting in the second data input (e.g. an image) any object the user queries for (i.e. a class of interest defined by the user), by entering a language input in the form of a textual query, e.g. “Gargoyle”, even if that object has not been employed during training the multimodal model. For example, the open vocabulary detector may generate data defining a bounding box for a portion of the image (second data input) depicting a gargoyle.

Zero-shot open vocabulary detection, in the context of object detection, refers to a case in which not even one location-identifying annotation (e.g. bounding box) of the object defining the class of interest was used during training of the open vocabulary detector. Note that this definition allows for the existence of the object in the training set images as long as no annotations are associated with it. The definition permits weak supervision, e.g. an image-text dataset where the object is mentioned in the text, can be used in the training as long as no bounding boxes are provided.

A common approach to building an open vocabulary detector is to borrow from the design of standard closed vocabulary detectors (i.e. detectors capable of detecting only a fixed set of predetermined classes) which incorporate second trained neural network to generate an image region embedding of an input image; the image region embedding is used (e.g. by a fully connected layer) to generate a bounding box for any object in the image which is one of the set of classes. The open vocabulary detector is formed by modifying the bounding box classification procedure. Instead of producing logits for the fixed set of classes via a fully connected layer, as in a closed vocabulary detector, an open-vocabulary detector obtains a score for the textual query by forming a scalar product between an text embedding of the textual query produced by the language model, and an image region embedding produced by an adaptive unit (including a detection head) of the open vocabulary detector. The image region embedding is produced by the adaptive unit based on data obtained from the image (second data input). The zero-shot capability relies on good alignment between the embedding of the textual query and the image region embedding even for content which was not used in training the adaptive unit.

Many works freeze the pre-trained language model during the training of the open vocabulary detector, since training the pre-trained language model risks catastrophic forgetting of content which is not used in the training of the detection head. Other work trains the language model but at a reduced learning rate (e.g. controlled by a learning rate parameter which takes a value which is small but not zero).

Typically, the open vocabulary detector includes a second (pre-)trained neural network which, in the case of second data inputs which are images, is termed a “visual backbone”. The second neural network receives the second data input, and generates an output (e.g. a set of feature maps) which is an input to the adaptive unit of the open-vocabulary detector.

For a second data input which is an image, the adaptive unit may comprise a feature pyramid network, as described by Tsung-Yi Lin, et al., “Feature pyramid networks for object detection”, in Proc. CVPR, 2017), followed by a plurality of detection heads which receive input from respective ones of the feature maps generated by the feature pyramid network. The adaptive unit is trained from scratch, so initially its outputs are not aligned with outputs of the language model.

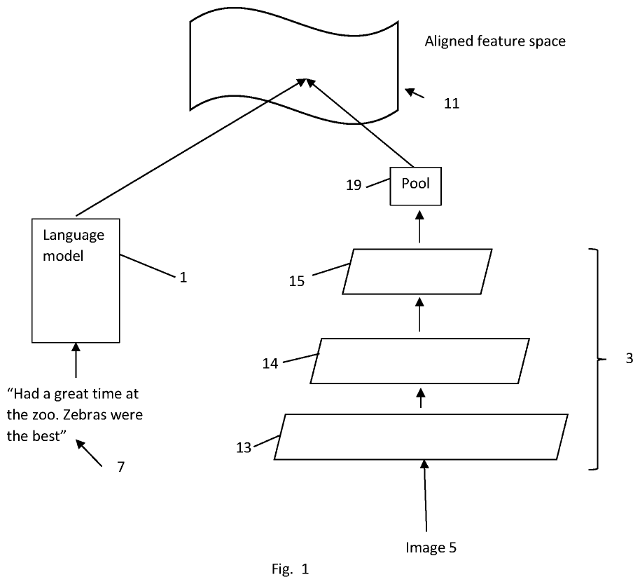

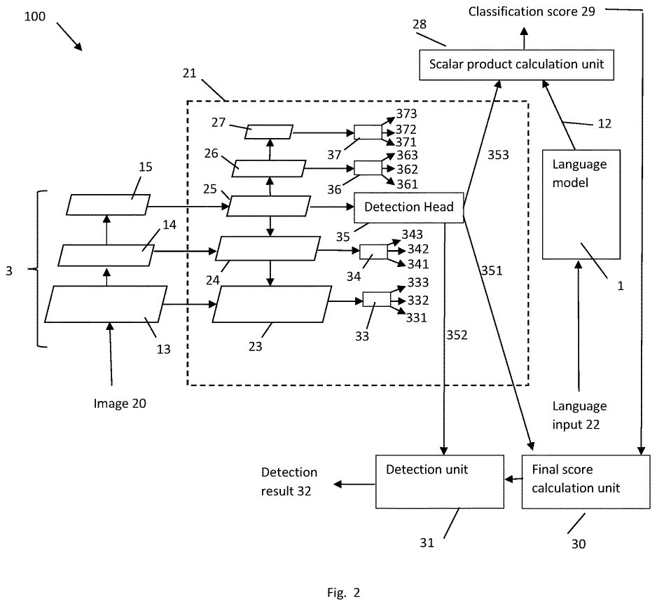

FIG. 1 illustrates a method for contrastive (pre-)training of a language model 1 and a second neural network (visual backbone) 3. The visual backbone and language model are pre-trained contrastively as in J.-B. Alayrac, et al, “Flamingo: a visual language model for few-shot learning”, in NeurIPS, 2022. The visual backbone 3 comprises a sequence (stack) of processing layers, e.g. convolutional layers. A first convolutional layer of the sequence receives an image 5, and each other convolutional layer of the sequence receives the output of the preceding convolutional layer. In fact, FIG. 1 shows not the convolutional layers themselves (which are omitted) but rather the outputs 13, 14, 15 of three of the convolutional layers of the sequence. These are feature maps 13, 14, 15. In other words, the second neural network (visual backbone) is represented schematically in FIG. 1 (and in FIG. 2 below) by the feature maps it successively produces. There may for example, be 5 convolutional layers, and the first feature map 13 may, for example, be the output of the third convolutional layer in the sequence; the feature map 14 may be the output of the fourth convolutional layer in the sequence; and the feature map 15 may the output of the 5^{th} convolutional layer. The feature map (e.g. feature map 15) output by the last convolutional layer is input to a pooling unit 19. The feature map 14 may have a pixel array which only includes half as many pixels along each side as the feature map 13. The feature map 15 may have a pixel array which is only includes half as many pixels along each side as the feature map 14.

The training of the language model 1 and the visual backbone 3 is performed using a training database of training examples. Each training example is a data input item which includes a language input 7 and a respective semantically-corresponding image 5, i.e. an image depicting, as pixelated intensity values (rather than as metadata of the image), an object which is described by at least some of the language input. For example, the language input 7 of one training examples may be “had a great time at the zoo. Zebras were the best”, and the respective image 5 of the training example may be an image depicting a zebra (and optionally other unrelated objects).

A first dataset is formed from the output of the language model 1. This first dataset may for example be the output of the language model itself, or a result of applying a function to the output of the language model. Similarly, a second dataset is formed from data output by the visual backbone, e.g. by applying the pooling unit 19 to the feature map 15 output by the last convolutional layer of the visual backbone 3. The two datasets may have the same number of components, and define respective points in a common feature space 11.

The language model 1 and the processing layers of the visual backbone 3 perform functions defined by respective sets of numerical parameters. The training of the language model 1 and the visual backbone is performed by iteratively varying these parameters. The language model 1 and visual backbone 3 may be trained jointly (that is, with updates to the parameters defining the language model 1 being substantially simultaneous with corresponding updates, or alternatively interleaved with updates, to the parameters defining the processing layers of the visual backbone 3). Each update is so as to increase a similarity measure (e.g. a dot product of) the first and second datasets. In practice, the update may be selected using a plurality (batch) of the training examples, such that the update increases a corresponding value of the similarity measure for most (or all) of the training examples of the batch. Following the training, the feature space 11 is said to be “aligned”, in that the similarity measure of the first and second datasets has a high value (i.e. meets a similarity criterion defined by a threshold) when the language input 7 and second data input 5 are semantically corresponding.

An adaptive system 100 (open-vocabulary detector) comprises the trained language model 1 and visual backbone 3 as shown in FIG. 2. This is a multi-modal model. In use, the adaptive system of FIG. 2 receives a data input item which includes a language input 22 referred to as a text query, and a second input of a different modality, which in this example, is an image 20. This generally follows the approach of Ankan Bansal, et al., “Zero-shot object detection”, in Proc. ECCV, 2018, of using a language model to generate text embeddings.

In the adaptive system 100, the trained language model 1 of FIG. 1 receives the language input 22, and based on it generates an output (“first output”, or “language model output”) 12.

Also in the adaptive system 100, the trained visual backbone 3 (second network) of FIG. 1 receives the image (second input) 20, and from it successively generates multiple feature maps. The visual backbone 3 is represented in FIG. 2 by three of the feature maps 13, 14, 15 it produces. These three feature maps 13, 14, 15 constitute an output of the visual backbone 3 (“second output”).

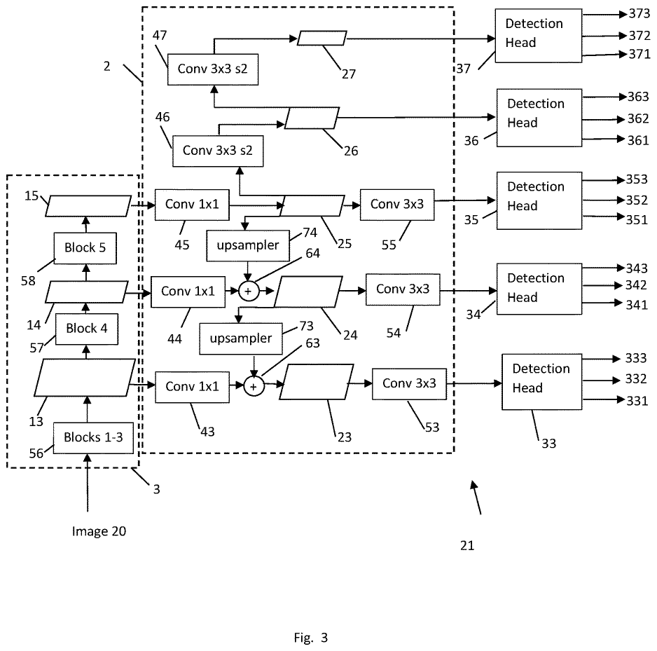

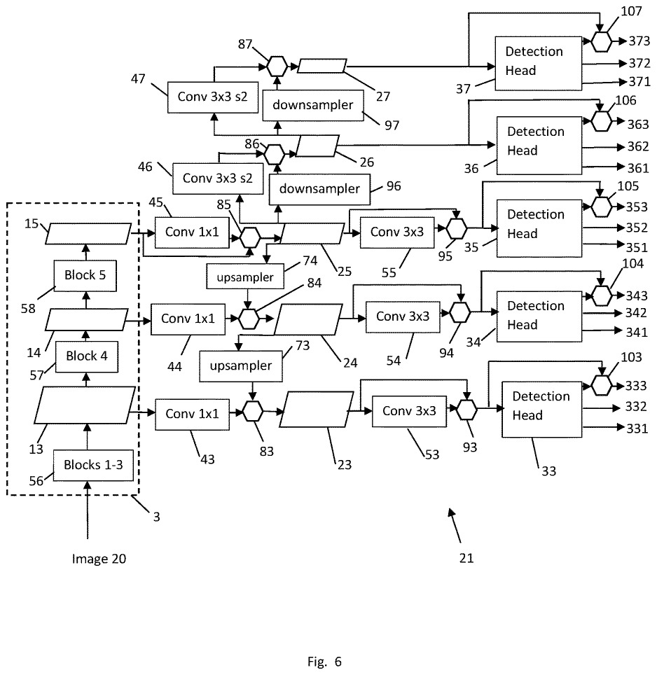

The adaptive system 100 further comprises an adaptive unit 21. The adaptive unit receives the feature maps 13, 14, 15 (that is, the “second output”). Using them it generates feature maps 23, 24, 25, 26, 27 using processing units (adaptive filters) and components which are not shown in FIG. 2 but which are described below with reference to FIG. 3 or FIG. 6. The feature maps 23, 24 25, 27 are passed, in some cases via further processing units not shown in FIG. 2, as respective inputs to detection heads 33, 34, 35, 36, 37 which are adaptive (i.e. perform respective functions defined by respective sets of numerical parameters which are iteratively trained during a training procedure described below).

Each detection head 33, 34, 35, 36, 37 generates dense detections (one or more numerical values associated with each of an, e.g. 2-dimensional, array of pixels) associated with three quantities: a quality score 331, 341, 351, 361, 371; bounding box coordinates 332, 342, 352, 362, 372; and classification features 333, 343, 353, 363, 373. The detection heads 33, 34, 35, 36, 37 may be implemented as the T-heads disclosed by Chengjian Feng, et al., “TOOD: Task-aligned one-stage object detection”, In Proc. ICCV, 2021, or FCOS heads, as described in Zhi Tian, at al, “FCOS: Fully convolutional one-stage object detection”, in Proc. ICCV, 2019.

The classification features 333, 343, 353, 363, 373 from each head are compared with the text embedding 12 generated by the language model 1, to determine a measure of the similarity between the classification features 333, 343, 353, 363, 373 and the text embedding.

This may be done (as in Ankan Bansal, et al. (2018), mentioned above, and other works such as Xiuye Gu, et al., “Open-vocabulary object detection via vision and language knowledge distillation”, in Proc. ICLR, 2022) by a scalar product calculation unit 28 configured to form a dot product between elements of the classification features and the text embedding 12, thereby forming classification logits for the text query (language input) 22.

These are classification probabilities, e.g. indicative of a likelihood that a corresponding portion of the image 20 has a certain classification. Final scores for all the dense detections are computed by a final score calculation unit 30, by multiplying the classification scores (classification probabilities) by the corresponding quality scores 331, 341, 351, 361, 371.

Non-maximum suppression (as described in P. F. Felzenszwalb, et al., “Object detection with discriminatively trained part-based models”, in IEEE PAMI, 32(9):1627-1645, 2010) is then applied to the final score by a detection unit 31, to select a corresponding portion of the bounding box data 332, 342, 352, 362, 372. This is a detection result 32 which is the output of the adaptive system. Note that although FIG. 2 only shows this being done for the data output by the detection head 35, it is to be understood that in fact the units 28, 30, 31 process the corresponding data generated by all the detection heads 33, 34, 35, 36, 37, to obtain the detection result 32.

The training of the detection heads 33, 34, 35, 36, 37 may follow the standard FCOS method, and improvements which have previously been suggested to it. In an example (which is not according to the first aspect of the present disclosure as discussed below, but may be used for the second aspect of the disclosure also discussed below), the adaptive unit 21 of the system 100 is trained within the system 100. The detection heads may be trained by supervised learning, using a training database of training examples. Each training example comprises an example data input item (i.e. a pair of a language input 22 and a second input (e.g. image 20)), and a corresponding desired output of the adaptive system (e.g. a ground truth bounding box).

The training using the training database may assign the dense predictions to a ground truth bounding box, or deem them to be negative through ATSS (see S. Zhang, et al, “Bridging the gap between anchor-based and anchor-free detection via adaptive training sample selection”, in Proc. CVPR, 2020). That is, certain detector head classification features are assigned to be positives for a particular class (defined by the text embedding 12) based on their pyramid level and location in the feature map. The same features are negatives for other classes, and all remaining features are negatives for all classes. For example, if an image 20 has a dog in it and no cat, then (i) some features depending on scale and location are positives for dog, (ii) features that are not positives for dog are negatives for dog, and (iii) all features are negatives for cat. Training then proceeds with the standard per-class binary focal loss (Tsung-Yi Lin, et al, “Focal loss for dense object detection”, in Proc. CVPR, 2017).

The quality branches of the detection heads 33, 34, 35, 36, 37 which produce the quality scores 331, 341, 351, 361, 371 may be trained using Intersection-over-Union (IoU) prediction losses (S. Wu, et al, “IoU-aware single-stage object detector for accurate localization”, in Image and Vision Computing, 2020). The bounding box branches of the detection heads 33, 34, 35, 36, 37 which produce the bounding box coordinates 332, 342, 352, 362, 372 may be trained using generalized IOU (gIoU) losses (H. Rezatofighi, et al, “Generalized intersection over union: A metric and a loss for bounding box regression”, in Proc. CVPR, 2019). The classification branches of the detection heads 33, 34, 35, 36, 37 which produce the classification features 333, 343, 353, 363, 373 may be trained using focal losses (Tsung-Yi Lin, et al., 2017, mentioned above). Free form textual queries are naturally supported, while it is still possible to detect a desired object class since the query text for that class (hereafter also referred to as the “class embedding”) can be produced by populating the default template (“A photo of a {object}”) with the class name.

Note that that training of the adaptive unit 21 is performed using a limited number of classes (much smaller than the number of classes used during the pre-training illustrated in FIG. 1), and in particular not using the objects which are used for testing the ability of the trained adaptive system to perform ZS OV detection.

FIG. 3 shows in more detail than FIG. 2, a first implementation of the visual backbone 3 and the adaptive unit 21 of the adaptive system 100 of FIG. 2.

In the case of FIG. 3, the visual backbone 3 is depicted as including a plurality of ordered convolutional layers 56 (e.g. three convolutional layers, “blocks 1-3”) which generate the feature map 13, where the first convolutional layer receives the image 20, and each successive convolutional layer receives the output of the preceding convolutional layer. The feature map 13 is input to a further convolutional layer 57 (“block 4”) to generate the feature map 14. The feature map 14 is input to a further convolutional layer 58 (“block 5”) to generate the feature map 15.

The adaptive unit 21 comprises a feature pyramid network 2 (FPN) and the detection heads 33, 34, 36, 36, 37. The feature pyramid network 2 includes processing units 43, 44, 45, 46, 47, 53, 54, 55. The processing units 43, 44, 45, 46, 47, 53, 54, 55 are modules which apply a respective adaptive filter, e.g. a convolution having a size specified in FIG. 3.

The feature map 15 is processed by the processing unit 45 (e.g. a 1×1 adaptive convolutional filter) to generate the feature map 25. The feature map 25 is processed by the processing unit 55 (e.g. a 3×3 adaptive convolutional filter) to generate a feature map which is input to the detection head 35. The processing units 45, 55 constitute a processing layer of the feature pyramid network 2. The feature maps 15 and 25 have the same pixel array size and number of numerical values per pixel. These may also be the pixel array size and number of numerical values per pixel of the classification features 353, and optionally also of the bounding box coordinates 352 and quality score 351.

The feature map 25 is also processed by a processing unit 46 (e.g. a 3×3 adaptive convolutional filter with a stride of 2 (“s2”)) to generate a feature map 26 of reduced pixel array size; specifically, the number of pixels along each side of the array is halved. The feature map 26 is used as the input to the detection head 36. The processing unit 46 constitutes a processing layer of the feature pyramid network 2.

The feature map 26 is also processed by a processing unit 47 (e.g. a 3×3 adaptive convolutional filter with a stride of 2) to generate a feature map 27 of reduced pixel array size; specifically, the number of pixels along each side of the array is halved. The feature map 27 is used as the input to the detection head 37. The processing unit 47 constitutes a processing layer of the feature pyramid network 2.

The feature map 25 is also processed by an upsampler 74, and added, by an addition unit 64, to the result of processing the feature map 14 with a processing unit 44 (e.g. a 1×1 adaptive convolutional filter), to generate a feature map 24. The feature map 24 has the same pixel array size as the feature map 14. The feature map 24 is processed by a processing unit 54 (e.g. a 3×3 adaptive convolutional filter), and the result is used as the input to the detection head 34. The processing units 44, 54 and addition unit 64 constitute another processing layer of the feature pyramid network 2. The feature maps 14 and 24 have the same pixel array size and number of numerical values per pixel. These may also be the pixel array size and number of numerical values per pixel of the classification features 343, and optionally also of the bounding box coordinates 342 and quality score 341.

The feature map 24 is also processed by an upsampler 73, and added, by an addition unit 63, to the result of processing the feature map 13 with a processing unit 43 (e.g. a 1×1 adaptive convolutional filter), to generate a feature map 23 having the same pixel array size as the feature map 13. The feature map 23 is processed by a processing unit 53 (e.g. a 3×3 adaptive convolutional filter), and the result is used as the input to the detection head 33. The processing units 43, 53 and addition unit 63 constitute another processing layer of the feature pyramid network 2. The feature maps 13 and 23 have the same pixel array size and number of numerical values per pixel. These may also be the pixel array size and number of numerical values per pixel of the classification features 333, and optionally also of the bounding box coordinates 332 and quality score 331.

The processing units 43, 44, 45, 46, 47, 53, 54, 55 and the detection heads 33, 34, 35, 36, 37 are trained during the training process of the adaptive unit 21.

In other implementations, the input image 20 may be processed by any number (e.g. zero, or one or more) of successive convolutional layers to generate the first feature map which is output to the FPN, and each further feature map which is output to the FPN may be generated from the preceding feature map by any number (zero, or one or more) of additional successive convolutional layers. Although the FPN is illustrated as having five processing layers, it may have any other number of layers, with any one or more of the processing layers receiving input feature maps from the visual backbone, and/or receiving up- or down-sampled feature maps generated by other processing layers.

In earlier publications, when training a zero-shot detector such as the adaptive system 100 of FIGS. 2-3 incorporating a pre-trained language model, a choice is made whether to train or to freeze the language model 1. Many works freeze it, following the natural intuition that the language model 1 learnt a comprehensive textual representations during pre-training, and fine-tuning it for detection on a small number of classes within the adaptive system 100 could make it forget about the unseen classes. However, freezing it also comes with downsides—the vision model is “forced” into the language-model “mold” making it less able to adapt to the task change from pre-training which only involved global image understanding. For this reason, some works train the language model as well, but typically use a smaller learning rate in order to prevent “catastrophic forgetting”.

Motivated by a realization that the main reason that systems with a frozen language model have poor detection performance is overfitting the visual representations to the small number of textual embeddings corresponding to the training classes used in training the adaptive system, a first aspect of the present disclosure proposes that the number of training examples is increased. This may be done by processing the language input of a training example of the training database using, instead of the language model 1, a modified variant of the language model 1 (“modified language model”), so that the textual embedding 12 is different.

A first possibility is, during the training of the adaptive system, to perform random temporary modifications of the language model, such as random “drop-out”. That is, at each of a number of times, one or more parameters of the language model 1 are randomly selected, and temporarily (i.e. for that time only) set to zero. Thus, a given language input 22 of a training example would produce a different textual embedding (language model output) 12 at different times. In other words, the influence of the training example is slightly different at different training iterations.

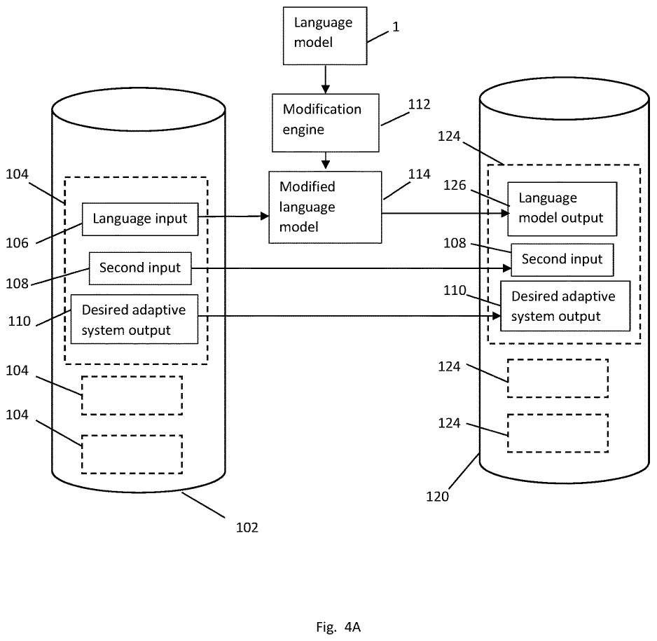

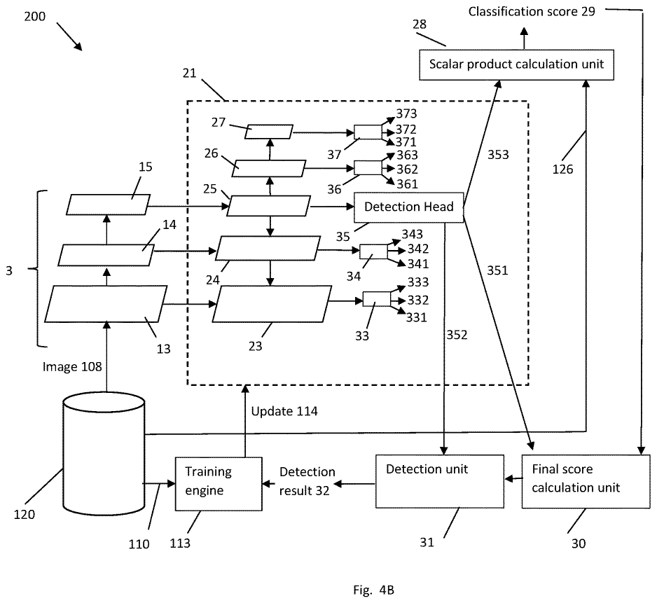

Another alternative, however, according to the first aspect of the present disclosure, is illustrated in FIG. 4A. This is to use a first training database 102 of “original” training examples 104 to generate a second training database 120 of additional training examples 124. This is done prior to the training of the adaptive unit 21. The second training database 120 is used for training the adaptive unit 21 of the adaptive system 100.

Each original training example 104 is of the kind discussed above (e.g. as used in a known ZS OV detector training processes explained above). It includes a language input 106, a second input (e.g. an image) 108, and a desired output 110 of the adaptive system 100 (e.g. a ground truth bounding box in the image 108 for an object of the class defined by the language input 106).

A modification engine 112 is used to modify the language model 1 to generate one or more modified language models 114. Each modified language model 114 is a “variant” of the language model 1. For example, the modification engine 112 may do this by random drop-outs, i.e. selecting one or more weights of the language model 1 and randomly resetting them (e.g. to zero, or a default value or a random value).

Each additional training example 126 is based on one of the original training examples 104 of the first training database 110. The additional training example 120 includes the second input 108 of the original training item 104, a language model output 126 generated by the modified language model 114 based on the language input 106 of the training example 104, and the desired output 110 of the adaptive system of the training example 110 (e.g. a ground truth bounding box). In other words, each additional training example 124 differs from the corresponding original training example 104 from which it is formed by including a language model output 126 of a corresponding modified language model 114 instead of the language input 106 of the corresponding original training example.

Note that multiple additional training examples 124 can be formed from a given modified language model 114 based on respective ones of the original training examples 104. Multiple modified language models 114 may be formed, and, for each modified language model 114 one or more additional training examples 124 may be formed based on different respective ones of the original training examples 104. The number of training examples 124 in the second training database may be greater than the number of training example 104 in the first database (e.g. the number of training examples from which the training examples 124 were formed), and this reduces a risk of overfitting of the training examples.

Note that the second training database 120 may also include training examples which are generated from corresponding ones of original training examples 104 by inputting the language input of the original training example to the language model 1 (rather than a modified language model 114 produced by the modification engine 112) to generate a corresponding language model output, and adding the language model output second input 108 and desired adaptive system output 110 of the original training example, to form a training example of the second database 120.

A training system 200 for training the adaptive unit 21 of the adaptive system 100 using the second training database 120 may be as illustrated in FIG. 4B. In contrast to the adaptive system of FIG. 2, the language model 1 is replaced by the second training database 120, formed of the additional training examples 124. Thus, the process of training the adaptive unit 21 does not require the use of the language model 1 during the training of the adaptive unit 21 using the second training database 120.

During one iteration of the training process of the adaptive unit 21, the language model output 126 of one of additional training examples 124 in the second training database 110 is transmitted to the scalar product classification unit 28, which uses it in place of the language model output 12 of FIG. 2. The second input 108 of the additional training example 124 is transmitted to the visual backbone 3, to generate feature maps 13, 14, 15 which are inputs to the adaptive unit 21. The outputs 331, 332, 333, 341, 342, 343, 351, 352, 353, 361, 361, 363, 371, 372, 373 of the adaptive unit 21 are used in the same manner as described above in relation to FIG. 2, to generate a detection result 32. Based on the discrepancy between the detection result 32 and the desired adaptive system output 110 of the additional training example 124, the training engine 113 generates an update to some or all of the variable numerical parameters of the adaptive unit 21. This is done by the known methods explained above.

Using the second training database 120 instead of the language model 1 in the training system 200 may reduce the amount of data which the computer implementing the training system 200 is required to manipulate during the training process, in turn making the training process more suitable for implementation in a computer system (e.g. a hardware accelerator) having limited memory, e.g. a memory which is too small to contain the (often billions of) numerical parameters defining the language model. By using a second training database 120 including the additional training examples 124, the hardware accelerator is not required to store the language model 1 during training of the adaptive unit 21.

Although the first aspect of the present disclosure has been explained above with reference to the adaptive system of FIG. 1, more generally it could be used in any adaptive system which includes a trained language model which processes a language input of a data input item and an adaptive unit which receives data based on a second input of the data input item, where the adaptive unit is to be trained using a first training database of training examples which are data input items comprising language inputs and second inputs.

A method 400 which an example of the first aspect of the disclosure is illustrated in FIG. 4C. Method 400 may implemented as computer programs executed by one or more computers in one or more locations. For example, the systems of FIGS. 4A and 4B may implement the method 400.

Method 400 includes a first step 401 of using a training database of training examples to generate additional training examples form a second training database. This includes:
a sub-step 4011 of modifying a trained language model (e.g. by random dropout) to form a modified language model;
a sub-step 4012 of inputting the language input of one of the training examples to the modified language model, to generate a corresponding language model output; and
a sub-step 4013 of forming an additional training example, including the second input of the data input item of the training example, the corresponding language model output, and the corresponding desired output of the adaptive system of the training example.

The sub-steps 4012 and 4013 may be performed multiple times, to generate corresponding additional training examples. Furthermore, the sub-step 4011 may be performed multiple times to generate multiple corresponding modified language models, and for each modified language model, sub-steps 4012 and 4012 may be performed one or more times using that modified language model.

Method 400 further includes a second step 402 of using the second training database to train the adaptive unit of an adaptive system, such as the adaptive system 100 of FIGS. 2-3.

Experiments were carried out in relation to the approach above. The results are shown in Table 1. Algorithms according to method 400 are referred to in Table 1 as “variants”. Results for a number of comparative example algorithms are given also.

In all these experiments, the visual backbone used was the NFNet-F0 backbone (A. Brock, et al., “High-performance large-scale image recognition without normalization”, arXiv preprint arXiv:2102.06171, 2021). The testing was performed using the LVIS 1.0 object detection benchmark (Agrim Gupta, et al, “LVIS: A dataset for large vocabulary instance segmentation”, in Proc. CVPR, 2019). “Rare” class annotations were removed from the training set, keeping only “frequent” and “common” annotations (often called “LVIS-base”). Evaluation was performed on all classes, with the result being shown in Table 1 as mAPₐₗₗ. Table 1 also shows as mAPᵣₐᵣₑ. This is a critical parameter because it measures the zero-shot performance, with “rare” classes playing the role of the unseen classes. All experiments were run for three different training runs, with three different respective random seeds, and the mean values are shown in Table 1, with the corresponding standard deviations being shown by the “±” symbol. “Speed” is measured as the number of gradient steps per second, while “memory” denotes the peak accelerator memory usage.

The algorithms for which data is given in respective rows of Table 1 are as follows:
(i) training in a system as shown in FIG. 2, with both the adaptive unit 21 and the learning model 1 being trained, and in particular with the learning model 1 being trained using a learning rate parameter of 1, as in the pre-training;
(ii) the same as (i) except that the learning rate parameter is 0.01 to reduce the risk of catastrophic forgetting;
(iii) training in a system as shown in FIG. 2 with no training of the learning model;
(iv) training in a system as shown in FIG. 2, but, during the training, performing random dropout to generate additional training examples;
(v) performing an algorithm as shown in FIG. 4C, using a single modified learning model;
(vi) performing an algorithm as shown in FIG. 4C using 64 modified learning models.

TABLE 1

| LM train or | | | | |
|---|---|---|---|---|
| freeze | mAPₐₗₗ | mAPᵣₐᵣₑ | Speed | Memory |
| (i) Train with | 12.0 ± 15.0 | 5.2 ± 7.3 | 13 | 14.1 |
| learning rate | | | | |
| ratio 1 | | | | |
| (ii) Train with | 33.2 ± 0.3 | 16.5 ± 0.95 | 1.3 | 14.1 G |
| learning rate | | | | |
| ration 0.01 | | | | |
| (iii) Freeze | 24.4 ± 13.2 | 13.0 ± 8.51 | 1.9 | 10.4 G |
| (iv) | 31.8 ± 0.2 | 18.7 ± 1.39 | 1.7 | 10.4 G |
| Freeze + Dropout | | | | |
| (v) 1 Variant | 16.3 ± 13.0 | 6.9 ± 7.89 | 2.6 | 9.4 G |
| (vi) 64 Variants | 32.1 ± 0.31 | 18.9 ± 1.13 | 2.6 | 9.5 G |

It will be seen that algorithm (i) is subject to low performance both in mAPₐₗₗ and mAPᵣₐᵣₑ, presumably due to forgetting. It is also slow and has a high memory requirement. Algorithm (ii) performs better than algorithm (i) but is likewise slow with a high memory requirement. Algorithm (iii) performs less well than algorithm (ii), but is slightly faster and has slightly less memory requirement. Algorithm (iv) performs significantly better than algorithms (i)-(iii), is faster and has slightly lower memory requirement than algorithms (i) and (ii). Algorithm (v) performs better than algorithm (i), though not as well as algorithms (ii)-(iv). On the other hand, it is far faster than algorithms (ii)-(iv), and has reduced memory requirement. Algorithm (vi) has the best performance as measured by mAPᵣₐᵣₑ, and is almost as good as the best algorithm as measured by mAPₐₗₗ (i.e. algorithm (ii)). Algorithm (vi) is also faster than any of algorithms (i)-(iv), and uses a lower amount of memory than algorithms (ii)-(iv).

The data in Table 1 is from three training runs per algorithm, and at least one of the three training runs failed in the case of algorithms (i), (iii) and (v). There was no failure for algorithm (vi).

Note that the method of FIG. 4C (e.g. algorithms (v) and (vi)) makes it possible to omit the language model 1 during the training of the adaptive unit 21, as precomputed text embeddings generated in step 4012 are used instead. This makes training faster and provides memory savings. It can be essential as detection training often requires high-resolution images which, for some large vision models, makes it hard to fit even a batch size of 1 into the accelerator memory.

An additional advantage of the variants approach is that it makes possible a novel form of “self-training”. Self-training refers to a procedure to improve the low-shot performance of a detector. A detector is first trained, and then it is used to pseudo-label additional images, which are in turn used to train a better detector.

In the present case this may be carried out in a three stage process. Firstly, an adaptive unit 21 is trained in the manner explained above (step 1), and used to form an adaptive system 100 constituting an OV detector. The detector is then used (step 2) to pseudo-label an additional dataset that contains only image-text pairs scraped from the internet (where the text is a caption associated with the image), i.e. it contains weak image-level information (the text), without any human supervision or finer-grained annotations such as classes, bounding boxes or segmentation. The detector uses the text embedding of the entire caption as the object query, and a training example is created using the highest scoring box per image (a “pseudo-bounding box”) if it passes a confidence threshold of 0.25. Finally, in step 3 a new stronger OV detector is trained by method 400 based on a training dataset which combines the strongly supervised data used in step 1 with the training examples created in step 2. The single pseudo-bounding box per image is deemed to correspond to the entire caption, and other captions in the batch are used as negatives. This process requires the use of high-resolution images, and as noted above, it is hard to fit even a batch of size 1 into the accelerator memory, so it is hardly possible to carry out this procedure without using the “variants” approach, which means that the accelerator memory does not have to store the language model also.

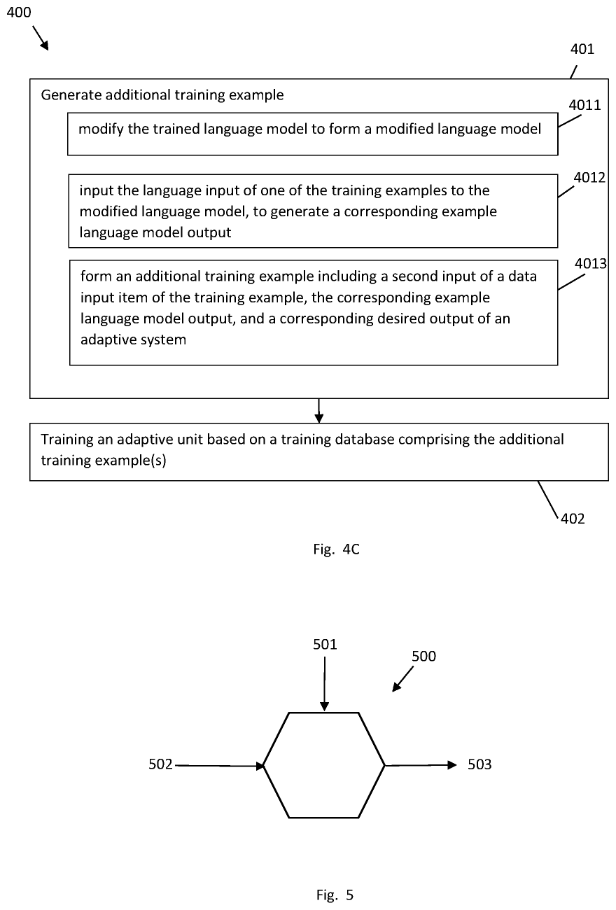

Turning to FIG. 5, a notation is explained which is used in FIG. 6. FIG. 5 depicts a module called a “gate”, which has a first input 501, which is a dataset (e.g. feature map) denoted x, and a second input 502, which is a dataset (e.g. feature map) denoted y. The output 503 of the gate 500 is a dataset (e.g. a feature map) which is a weighted sum x(1−tan α)+y tan α, i.e. a weighted combination of the inputs 501, 502. Here α is a control parameter of the gate.

FIG. 6 shows an alternative implementation of the adaptive unit 21 of the adaptive system of FIG. 2, according to a second aspect of the present disclosure. Gates and “shortcuts” are added to the adaptive unit 21, as compared to that of FIG. 4C, so that the gates can be controlled, by a suitable choice of the control parameter a for each gate, to forward the feature maps 13, 14, 15 (which due to the pre-training are aligned with the text embeddings) to the output of the detection heads 33, 34, 35 without modification.

Specifically, the gates are placed to follow the “flow” of the final backbone features by applying the following operations: (i) if the feature maps 13, 14, 15 are mixed with another signal, a gate 500 is added that zeroes-out the second signal at the start of training, (ii) if an alignment-preserving operation is performed (e.g. upsampling), no gate is added, (ii) if an alignment-damaging transformation is performed (e.g. a convolution), a shortcut connection is added, and a gate is added such that the output of the gate equals the input to the shortcut at the start of training.

Applying these rules to the adaptive unit of FIG. 4C gives the adaptive unit 21 of FIG. 6 which may be used in place of the adaptive unit 21 of FIG. 2 in the adaptive system 100 of FIG. 1. Note that in some cases some of the gates may be omitted, e.g. below a case is discussed in which gates are added to only one of (i) the classification branches, and (ii) the feature pyramid network. The adaptive unit 21 may be trained in the adaptive unit training system of FIG. 4 (e.g. if the training is according to the first aspect of the disclosure) or inside the adaptive system 100 using the known training methods described above. In both cases, the training process comprises additional control of the control parameter(s) a for each gate to gradually increase it (e.g. from zero or near zero) during the training.

The adaptive unit 21 employs multiple instances 83, 84, 85, 86, 87, 93, 94, 95, 103, 104, 105, 106, 107 of a gate as shown in FIG. 5 in various locations. In each case, the gate is represented as a hexagon, as in FIG. 5. Note that in all instances of the gate in FIG. 6, the second input 502 to the gate is the one which is shown as an arrow pointing to the hexagon from the left. The first input 501 of the gate is shown as an arrow pointing to the hexagon from above (e.g. in the case of gate 83) or below (e.g. in the case of gate 86).

The processing units 45, 53, 54, 55 are supplemented, as compared to FIG. 3, by a respective gate 85, 93, 94, 95. The respective gate 85, 93, 94, 95 receives the output of the processing unit 45, 53, 54, 55 to the 502 input of the gate 85, 93, 94, 95, and a signal path is provided from the input to the processing unit 45, 53, 54, 55 to the 501 input of the gate 85, 93, 94, 95. Thus, each gate 85, 93, 94, 95 modifies the output of the corresponding processing unit 45, 53, 54, 55, to form the output of the gate 85, 93, 94, 95, i.e. a weighted sum of an input to the corresponding processing unit 45, 53, 54, 55 and the result of the function applied by the corresponding processing unit 45, 53, 54, 55 to the input to the corresponding processing unit 45, 53, 54, 55. The weighted sum is a function of the corresponding control parameter a of the gate 85, 93, 94, 95. The respective inputs to the detection heads 33, 34, 35 are the respective outputs of the gate 93, 94, 95.

The processing units 46, 47 are supplemented, as compared to FIG. 3, by the addition of a respective downsampler 96, 97 and a gate 86, 87. A signal path is provided, via the respective downsamplers 96, 97, from the input to the processing unit 46, 47 to the 501 input of the gate 86, 87. Thus, each gate 86, 87 modifies the output of the corresponding processing unit 46, 47, (which it receives at its input 502) to form the output of the gate 86, 87, i.e. a weighted sum of a down-sampled version of the input to the corresponding processing unit 46, 47 and the result of the function applied by the corresponding processing unit 46, 47 to the input to the corresponding processing unit 46, 47. The weighted sum is a function of the corresponding control parameter a of the gate 86, 87.

The addition units 63, 64 of FIG. 2 are replaced by respective gates 83, 84. The gates 83, 84 output a weighted sum of a upsampled version of the respective feature maps 24, 25 generated in the next higher processing layer, and the result of the function applied by the corresponding processing unit 43, 44 to the input to the corresponding processing unit 43, 44 (i.e. the feature maps 13 and 14 respectively). Each weighted sum is a function of the corresponding control parameter a of the respective gates 83, 84.

The classification branches of the detection heads 33, 34, 35, 36, 37 which produce the classification features 333, 343, 353, 363, 373, are supplemented, as compared to FIG. 3, by the addition of a respective gate 103, 104, 105, 106, 107, and a signal path from the input to the classification branch to the 501 input of the respective gate 103, 104, 105, 106, 107. Thus, each gate 103, 104, 105, 106, 107 modifies the output of the corresponding classification branch, to form a weighted sum of the input to the branch, and the result of the function applied by the corresponding classification branch to the input to the corresponding classification branch. Each weighted sum is a function of the corresponding control parameter a of the respective gates 103, 104, 105, 106, 107.

The control parameter a may be the same at any given time for all the gates 83, 84, 85, 86, 87, 93, 94, 95, 96, 97, 103, 104, 105, 106, 107, 108, or at any given time a may be different for different ones of the gates (i.e. at any time there are multiple values of the corresponding control parameters). For a given gate, the control parameter a rises gradually during the training of the adaptive unit 21 from an initial, low value (e.g. zero, or very slightly above zero) to a high value (e.g. π/4 so that tan α equals 1). For the initial value of the control parameter, the 502 inputs to the gates are given no weight. Thus, the feature maps 23, 24, 25 are the same as the respective feature maps 13, 14, 15, and the classification features 333, 343, 353, 363, 373 are the same as the respective feature maps 13, 14, 15, 26, 27. In other words, the adaptive unit 21 of the adaptive system has no effect on the feature maps 13, 14, 15, so that the classification features 333, 343, 353, 363, 373 are still aligned with the textual embedding 12 of the language input 22. During the training procedure, as the value(s) of the control parameter(s) increase, the processing units 43, 44, 45, 46, 47, 53, 54, 55 exert an increasing influence on the output of the adaptive unit 21. Similarly, the classification features 333, 343, 353, 363, 373 are increasingly influenced by the respective classification branches of the detection heads 33, 34, 35, 36, 37, but because the output of the adaptive unit 21 was initially aligned with the textual embedding 12, that alignment persists.

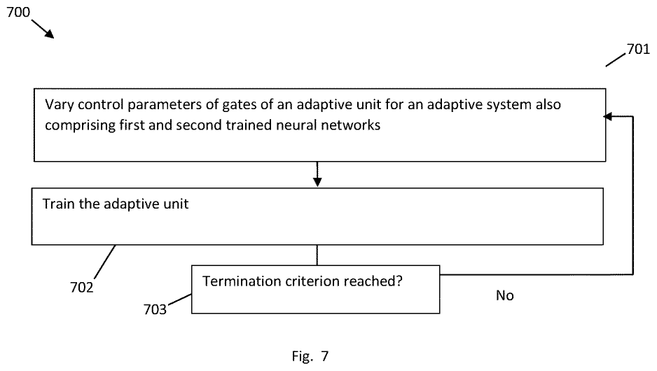

A method 700 which is suitable for performing a training procedure for the adaptive system 100 in the case that the adaptive unit 21 is realized as in FIG. 6, is illustrated in FIG. 7. Method 700 may implemented as computer programs executed by one or more computers in one or more locations. For example, the system of FIG. 4B may implement the method 700. Alternatively, the adaptive system 100 of FIG. 1 may be supplemented with a training engine equivalent to training engine 113 of FIG. 4B so that method 700 may be performed within the adaptive system 100.

Method 700 includes a set of steps 701, 702, 703 performed repeatedly, starting from an initial (low, e.g. zero) value of the control parameter(s).

In step 701, the control parameter(s) of one or more of the gates are increased by a small amount.

In step 702, a training step is performed to update some or all of the numerical parameters of the adaptive unit 21 based on the training database, as explained above with reference to FIGS. 1-3, and optionally using the method according to the first aspect of the disclosure as explained with reference to FIGS. 4A-4C.

In step 703 it is determined whether a termination criterion has been reached (e.g. whether the parameters of the adaptive system were changed by less than a threshold amount in the last performance of step 702). If not, the method returns to step 701.

Table 2 shows results of experiments using the method 700 of FIG. 7 (“alignment preserving architectures”, APA). The experiments were carried out using a visual backbone 3 which is the NFNet-F0 backbone with T-heads as the detection heads. Rows of Table 2 containing a tick mean that the method 700 of FIG. 7 was applied to the feature pyramid network 2 (i.e. by including gates 83, 84, 85, 86, 87, 93, 94, 95 as shown in FIG. 6, and operating them during the training of the adaptive unit according to FIG. 7) and/or to the detection heads 33, 34, 35, 36, 37 (i.e. by including gates 103, 104, 105, 106, 107 as shown in FIG. 6, and operating them during the training of the adaptive unit according to FIG. 7).

TABLE 2

| Are controllable | Are controllable | | |
|---|---|---|---|
| gates used in the | gates used for the | | |
| FPN? | detection heads? | mAPₐₗₗ | mAPᵣₐᵣₑ |
| | | 32.1 ± 0.31 | 18.9 ± 1.13 |
| ✓ | | 32.4 ± 0.44 | 18.3 ± 1.58 |
| | ✓ | 33.3 ± 0.15 | 19.6 ± 0.49 |
| ✓ | ✓ | 33.8 ± 0.15 | 20.9 ± 0.34 |

Similar results have been found experimentally using FCOS heads. Similar results were also found in experiments in which the backbone had an NF-F6 architecture.

Applying APA in both the FPN and the detection heads leads to the best performance. However, as shown in Table 2, it is possible to perform it only for the FPN or only for the detection heads. Of these two alternatives, Table 2 suggests that it is more valuable to apply the FIG. 7 technique to the detection heads than the FPN. This may be because each detection head is much deeper, and therefore without APA it takes longer to re-learn the feature alignment in the detection head than in the FPN.

Although FIGS. 1-7 are explained above with reference to the case that that second inputs are (still) images, in variations they may be sound signals or moving images (videos). In the case of sound signals, the visual backbone can be replaced by any known system for detecting features within sound signals. In the case of moving images, the input to the adaptive unit may be feature maps generated by a visual backbone from a plurality of the images.

There is now a discussion of applications of the trained adaptive systems proposed above.

In one example, as noted, the second input of each data input item may comprise a sound signal (i.e. an audio data item comprising a representation of a digitized audio waveform e.g. a speech waveform, e.g. captured from the real-world using a microphone). Such a representation may comprise samples representing digitized amplitude values of the waveform or, e.g., a time-frequency domain representation of the waveform such as a STFT (Short-Term Fourier Transform) or MFCC (Mel-Frequency Cepstral Coefficient) representation. In one application, a user may generate a language input (e.g. by typing, or by speaking into a microphone to generate a signal which is transmitted to a speech-to-text converter) which is “Car horn”. Upon processing a data input item including the first and second inputs, the adaptive system may output label data indicating the location(s) of any car horn sounds in the sound signal.

Instead of a data item representing an audio waveform, the data item may represent the waveform of any signal e.g. a signal from a sensor e.g. a sensor sensing a characteristic of the real world, e.g. an object in the real world. In one application, a user may generate a language input which is e.g. “Unstable”. Upon processing a data input item including a first input which is the sensor signal and the first input, the adaptive system may output label data indicating the location(s) of any unstable portions of the sensor signal.

In another example, the second image of each data input item may be an image, such a still, two-dimensional image, or a moving image (i.e. a video). The image may be one captured from the real-world, such as by a camera. For example, in one application, a user may generate a language input which is “Horse”. Upon processing a data input item the image and the first input (language input), the adaptive system may output label data indicating the location(s) of any images of horses in the image. Note that the system may be effective in this task even if none of the examples used to train the adaptive system related to horses.

The second input of each data input item may comprise a dataset having a dimension greater than one, e.g. the second input may representing a two-dimensional (still) image. In this case, some or all of the processing units may apply an adaptive filter such as a 1×1 convolution or two-dimensional convolutions, such as an n×n convolution in which n is an integer higher than one.

The feature vectors generated by the layers of the second trained neural network and the processing layers may also be two-dimensional arrays of values in this case.

In this case, an item of label data may be a bounding box defining a portion of the image containing an object described by the corresponding set of classification features. Alternatively or additionally, the label data may define a segmentation of the image of the image into regions defined by the classification features and regions which are not.

In this case, a detection heads may for example, output a two-dimensional array of data, in which each element of the array is a set of classification features and a corresponding array of label data. The number of points of the classification features array may be much lower than the number of pixels of the label data, with the ratio depending upon the extent to which the resolution of the original label data is reduced to form the corresponding array, or from another point of view the scale in the image of objects described by the set of classification features. Each point of the array may correspond to a region of the image, and the set of classification features for the point may indicate what object is shown in that region. The label data may indicate the position (e.g. in the region) of the object.

In one application, the user may generate a language input which is, for example, “flying cartoon spaceship”, and the trained adaptive system may output data which is bounding box(es) showing the location(s) of any flying cartoon spaceships in the image. Note that the system may be effective in this task even if the examples used to train the adaptive system did not include images of spaceships or cartoon images.

In another application, the image may be a medical image, such as an X-ray image, CAT scan or MRI image. The user may generate a language input which is, for example, “matière cancéreuse” (French for “cancerous matter”), and the trained adaptive system may output segmentation data indicating the locations of cancerous matter in the medical image. Note that the system may be effective in this task even if the examples used to train the adaptive system contained only English-language text.

In another example, the second input of each data input item may comprises a dataset representing a video (i.e. a sequence of image frames), such as one captured by a video camera. In this case, the convolutional layers of the second trained neural network, and the processing unit(s) may apply an adaptive filter such as a three-dimensional convolution. For example, the second input (video) may be partitioned into a number of (optionally overlapping) groups of multiple frames, and the groups of frames may be successively passed through the second trained neural network and the adaptive unit of the adaptive system, to generate corresponding classification features, label data and optionally quality scores. The feature vectors generated by the layers of the second trained neural network and the processing layers, may be three-dimensional arrays of values.

In one application, the user may generate a language input which is, for example, “skiing”, and the trained adaptive system may output data which indicates frames in the video, and optionally locations in the frames, where skiing activity is carried out. Note that the system may be effective in this task even if the examples used to train the adaptive system did not include a video showing skiing.

According to third aspect, there are provided one or more computer storage media, e.g. tangible computer storage media or other computer program products, storing instructions that when executed by one or more computers cause the one or more computers to perform the operations of the respective methods of the first and second aspects.

According to a fourth aspect, there is provided a system comprising one or more computers and one or more storage devices communicatively coupled to the one or more computers. The one or more storage devices may store instructions that, when executed by the one or more computers, cause the one or more computers to perform operations of the respective methods of the first and/or second aspects.

The subject matter described in this specification can be implemented in particular embodiments so as to realize one or more of the following advantages.

The first aspect of the disclosure allows an adaptive system which incorporates a very large pre-trained neural network (e.g. language model) to be trained using a computer system which has limited computational resources, e.g. a memory space which is not large enough to store the parameters of the language model). The additional training examples produced using variants of the trained language model upon receiving corresponding inputs can be used instead of using the full language model, and they occupy a much smaller amount of memory space. Experimentally it has been found that using these examples can avoid overfitting, compared to using examples which are generated from the language model in its original (i.e. unmodified form). This greatly reduces the computational resources needed to train the adaptive unit of the adaptive system, or, from another point of view, leads to a trained adaptive system which, for a given set of computational resources used to train it, performs its desired task more effectively.

The second aspect of the disclosure, improves the training procedure for the adaptive unit of the adaptive system, because it allows the iterative procedure of training the adaptive unit to begin from a state in which the adaptive unit does not interfere with pre-existing relationship between data generated by the first and second trained neural network. For example, a feature of the output of the second trained neural network when the second trained network receives a second input of a training example will immediately be available to train the detection head. This feature may have a critical relationship with feature of the output of the first trained neural network. By contrast, in the absence of the gates that feature may initially be removed by the processing units (adaptive filters) of the adaptive unit, and possibly never become available to the detection heads even when the processing units are trained. Experimentally it has been found that the second aspect of the disclosure greatly reduces the computational resources needed to train the adaptive unit of the adaptive system, or, from another point of view, leads to a trained adaptive system which, for a given set of computational resources used to train it, performs its desired task more effectively.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them.

Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method of training an adaptive unit for an adaptive system which includes a trained language model and the adaptive unit, the adaptive system being for processing data input items which each include a language input and a second input,
the trained language model being configured, upon the adaptive system receiving a data input item, to generate a language model output from the language input of the data input item,
an output of the adaptive system, upon receiving a data input item, being based on the corresponding language model output and an output of the adaptive unit based on the second input of the data input item,
the method employing a first training database of training examples which each comprise an example data input item and a corresponding desired output of the adaptive system,
the method comprising:
(i) generating one or more additional training examples for training the adaptive unit by:
modifying the trained language model to form a modified language model;
for each additional training example, inputting the language input of one of the training examples to the modified language model, to generate a corresponding language model output; and
forming the additional training example including the second input of the data input item of the training example, the corresponding language model output, and the corresponding desired output of the adaptive system of the training example; and
(ii) following the generation of the one or more additional training examples, training the adaptive unit based on a second training database comprising the one or more additional training examples.

2. The method of claim 1 in which modifying the trained language model comprises re-setting at least one of a plurality of numerical parameters defining the language model.

3. The method of claim 1 in which said training of the adaptive unit is conducted using a hardware accelerator based on the additional training examples, the hardware accelerator not storing the language model during said training.

4. The method of claim 1 in which the training of the adaptive unit is performed within an adaptive unit training system comprising the adaptive unit, the second training database, and a training engine configured to perform successive updates to numerical parameters defining the adaptive unit,
each update to the numerical parameters defining the adaptive unit being to increase a measure of similarity between, for one of more of the additional training examples, the corresponding desired output of the adaptive system and a corresponding detection result,
the corresponding detection result being generated from an output of the adaptive unit based on the corresponding second input of the additional training example, and from the corresponding language model output of the additional training example.

5. The method of claim 1, in which the adaptive system comprises a second trained neural network arranged to receive the second input of a data input item,
the adaptive unit of the adaptive system being arranged, upon the second trained neural network receiving the second input of a data input item and generating a corresponding output, to receive the output of the second trained neural network and to generate an adaptive unit output;
the output of the adaptive system being based on the adaptive unit output and the language model output generated by the language model from the corresponding language input of the data input item.

6. The method of claim 5 in which the second trained neural network comprises a sequence of convolutional layers,
a first convolutional layer of the sequence being arranged to receive the second input of the data input item and to generate a feature vector; and
at least one further convolutional layer of the sequence being arranged to receive a feature vector output by the preceding layer of the sequence and to generate a corresponding feature vector.

7. The method of claim 6 in which the sequence of layers of the second trained neural networks generate respective feature vectors of decreasing pixel array size.

8. The method of claim 6 in which the adaptive unit comprises a plurality of processing layers arranged to receive at least one feature vector, and apply a convolution to the feature vector using a processing unit of the processing layer.

9. The method of claim 8 in which the adaptive unit comprises a plurality of gates for corresponding ones of the processing units,
each gate being configured to control an output of the processing unit to be a weighted sum of an input to the processing unit and a convolutional function applied by the processing unit to the input to the processing unit, the weighted sum being a function of a corresponding control parameter of the gate;
said training of the adaptive unit of the adaptive system based on the training database comprising varying the corresponding control parameters of the gates starting from a value for the controllable parameter for which the output of the corresponding processing unit is independent of the corresponding function.

10. The method of claim 8 in which the processing layers comprise at least one processing layer which receives a feature vector generated by a corresponding layer of the second trained neural network.

11. The method of claim 8, in which the processing layers comprise at least one processing layer which receives a feature vector output by another of the processing layers.

12. The method of claim 11 in which the feature vector received from another of the processing layers has been subject to an up- or down-sampling operation.

13. The method of claim 11 in which the processing layers comprise at least one processing layer which forms a sum of a feature vector generated by a corresponding layer of the second trained neural network and a feature vector output by another of the processing layers.

14. The method of claim 8 in which the adaptive unit of the adaptive system further comprises a plurality of detection heads arranged to receive feature vectors output by corresponding ones of the processing layers, and to generate from the received feature vectors sets of classification features and corresponding items of label data, the output of the adaptive system being generated based on the classification features, the label data and the language model outputs.

15. The method of claim 14 in which the output of the adaptive system, for a given data input item, comprises at least one selected portion of the label data, the selected portion being selected based on the corresponding set of classification features and the language model output.

16. The method of claim 15 in which the selected portion is selected based on a similarity of the corresponding set of classification features to the language model output.

17. The method of claim 16 in which the selected portion is further selected based on a quality score for the classification features generated by the detection heads.

18. A method of training an adaptive unit for an adaptive system comprising first and second trained neural networks and the adaptive unit,
the adaptive system being arranged to receive data input items which each comprise a first input and a second input, the first and second trained neural networks being configured to receive the first and second inputs respectively and to generate respective first and second outputs,
the adaptive unit being configured in the adaptive system to receive at least the second output, to generate from the second output a plurality of sets of classification features and corresponding label data, an output of the adaptive system being based on a selection from the label data based on the first output and the corresponding sets of classification features;
the adaptive unit comprising one or more processing units, each processing unit being associated with a corresponding gate configured to control an output of the processing unit to be a weighted sum of an input to the processing unit and a function applied by the processing unit to the input to the processing unit, the weighted sum being a function of a corresponding control parameter of the gate;
the method comprising training of the adaptive unit based on a training database of training examples, each training example comprising a data input item and a corresponding desired output of the adaptive system,
the training comprising varying the corresponding control parameters of the gates starting from a value for the corresponding controllable parameters for which the output of the corresponding processing unit is independent of the corresponding function.

19. The method of claim 18 in which the first neural network is a trained language model and the first input of each data input item is a language input.

20. The method of claim 18 further comprising, during the training, using the adaptive system to generate, for a plurality of additional data input items received by the adaptive system, a plurality of corresponding outputs of the adaptive system, and adding to the training database additional training examples which each comprise one of the additional data input items and the corresponding output of the adaptive system.

21. The method of claim 18, in which the second trained neural network comprises a sequence of convolutional layers,
a first convolutional layer of the sequence being arranged to receive the first input of the data input item and to generate a feature vector; and
at least one further convolutional layer of the sequence being arranged to receive a feature vector output by the preceding layer of the sequence and to generate a corresponding feature vector.

22. The method of claim 21 in which the sequence of layers of the second trained neural networks generate respective feature vectors of decreasing pixel array size.

23. The method of claim 21 in which the adaptive unit comprises a plurality of processing layers arranged to receive a corresponding feature vector, at least one of the processing layers comprising a said processing unit configured to perform a convolution operation on the corresponding feature vector.

24. The method of claim 23, in which the processing layers comprises at least one processing layer which receives a feature vector output by another of the processing layers.

25. The method of claim 24 in which the feature vector received from another of the processing layers has been subject to an up- or down-sampling operation.

26. The method of claim 24 in which the processing layers comprise at least one processing layer which uses a said processing unit to form a sum of a feature vector generated by a corresponding layer of the second trained neural network and a feature vector output by another of the processing layers.

27. The method of claim 23 in which the adaptive unit of the adaptive system further comprises a plurality of detection heads arranged to receive feature vectors output by corresponding ones of the processing layers, and to generate from the received feature vectors sets of classification features and corresponding items of label data, the output of the adaptive system being generated based on the classification features, the label data and the language model outputs.

28. The method of claim 27 in which each of the detection heads is provided with a said processing unit to generate the sets of classification features.

29. The method of claim 28 in which the output of the adaptive system, for a given data input item, comprises at least one selected portion of the label data, the selected portion being selected based on a similarity of the corresponding set of classification features to the first output.

30. The method of claim 29 in which the selected portion is further selected based on a quality score for the classification features generated by the detection heads.

31-40. (canceled)

41. A system comprising:
one or more computers; and
one or more storage devices communicatively coupled to the one or more computers, wherein the one or more storage devices store instructions that, when executed by the one or more computers, cause the one or more computers to perform operations for training an adaptive unit for an adaptive system which includes a trained language model and the adaptive unit, the adaptive system being for processing data input items which each include a language input and a second input,
the trained language model being configured, upon the adaptive system receiving a data input item, to generate a language model output from the language input of the data input item,
an output of the adaptive system, upon receiving a data input item, being based on the corresponding language model output and an output of the adaptive unit based on the second input of the data input item,
the training employing a first training database of training examples which each comprise an example data input item and a corresponding desired output of the adaptive system,
the operations comprising:
(i) generating one or more additional training examples for training the adaptive unit by:
modifying the trained language model to form a modified language model:
for each additional training example, inputting the language input of one of the training examples to the modified language model, to generate a corresponding language model output; and
forming the additional training example including the second input of the data input item of the training example, the corresponding language model output, and the corresponding desired output of the adaptive system of the training example; and
(ii) following the generation of the one or more additional training examples, training the adaptive unit based on a second training database comprising the one or more additional training examples.
